(19) United States
(12) Patent Application Publication
(10) Pub. No.: US 2011/0199865 A1
(43) Pub. Date: Aug. 18, 2011

(54) Stepping motor control circuit and analogue electronic watch

(76) Inventor: Kenji Ogasawara, Chiba-shi (JP)

(21) Appl. No.: 12/931,995

(22) Filed: Feb. 15, 2011

(30) Foreign Application Priority Data
Feb. 16, 2010 (JP) 2010-031603

(51) Int. Cl. G04C 3/14; H02P 8/12; G04C 23/00

(52) U.S. Cl. 368/66; 318/696; 368/80

(57) ABSTRACT

The invention is aimed to be capable of detecting lowering of a power source without providing a circuit specific for voltage detection such as a comparator circuit. A stepping motor control circuit includes a battery configured to supply an electric power at least to a stepping motor, a rotation detection circuit configured to detect the state of rotation of the stepping motor, and a control unit configured to select an upgraded main drive pulse from a plurality of the main drive pulses having energy ranks different from each other and drive the stepping motor with the selected main drive pulse. The control unit is configured to determine that the voltage of the battery lowered to a level equal to or lower than the predetermined value when the main drive pulse reaches a maximum main drive pulse in a predetermined rank by upgrading it a number of times smaller than the predetermined number of times within a predetermined time.

### BACKGROUND OF THE INVENTION

1. Field of the Invention

The present invention relates to a stepping motor control circuit and an analogue electronic watch using the stepping motor control circuit.

2. Related Art

In the related art, a stepping motor is used, for example, for driving time-of-day hands of an analogue electronic watch.

For example, in an analogue electric wrist watch, a battery such as a primary battery and a secondary battery are used as power sources for driving the stepping motor or the like. In an analogue electronic watch having a mechanism for replacement of the battery or power generation when the voltage of the battery lowers to a level lower than a predetermined value, there is provided a source voltage detecting unit, for example, for urging the power generation.

The source voltage detecting unit includes a comparator circuit configured to compare the source voltage and a predetermined reference voltage, so as to detect that the source voltage lowers to a level below the reference voltage. In the analogue electronic watch having a mechanism for replacement of the battery or the power generation as described above, irregular movement of hands is performed so that power generation is urged or the movements of the hands are stopped irrespective of the driving state of the stepping motor (for example, see JP-A-62-238485).

However, the source voltage detecting unit disclosed in JP-A-62-238485 is configured to urge the battery replacement or the like when the source voltage lowers to a level equal to or lower than a certain voltage although the source voltage which is capable of driving the stepping motor depends on the performance of the corresponding stepping motor. Therefore, there arises a problem such that the replacement of the battery may be urged even though the source voltage is sufficient for rotating the stepping motor and, in such a case, remaining energy in the battery is wasted.

In addition, the comparator circuit requires a large surface area in terms of circuit elements such that a high resistance is used. Therefore, the circuit configuration becomes complicated, or an integrated circuit (IC) becomes large in scale, which causes problems in the analogue electronic watch or the like which requires a compact and light-weight structure.

### SUMMARY OF THE INVENTION

It is an aspect of the present application to enable detection of lowering of a source voltage without providing a circuit specific for voltage detection such as a comparator circuit.

According to another aspect of the present application, there is provided a stepping motor control circuit including a power source configured to supply an electric power at least to a stepping motor, a rotation detecting unit configured to detect the state of rotation of the stepping motor, and a control unit configured to select an upgraded main drive pulse from a plurality of main drive pulses having energy ranks different from each other to drive the stepping motor when the rotation detecting unit detects an energy shortage at the time of rotation with the main drive pulse, wherein the control unit determines that the voltage of the power source lowered to a level equal to or lower than a predetermined value when a main drive pulse is upgraded a number of times smaller than a predetermined number of times within a predetermined time in reaching the main drive pulses of a predetermined rank.

According to another aspect of the present application, there is provided an analogue electronic watch including a stepping motor configured to rotate time-of-day hands and a stepping motor control circuit configured to control the stepping motor, wherein the stepping motor control circuit is used as the stepping motor control circuit.

According to the stepping motor control circuit of the present application, detection of lowering of the source voltage is enabled without providing a circuit specific for voltage detection such as the comparator circuit.

According to the analogue electronic watch of the present application, detection of lowering of the source voltage is enabled without providing a circuit specific for voltage detection such as the comparator circuit.

### BRIEF DESCRIPTION OF THE DRAWINGS

FIG. 1 is a block diagram of an analogue electronic watch according to an embodiment of the invention; and

FIG. 2 is a flowchart relating to a stepping motor control circuit and the analogue electronic watch according to the embodiment of the invention.

### DESCRIPTION OF THE PREFERRED EMBODIMENTS

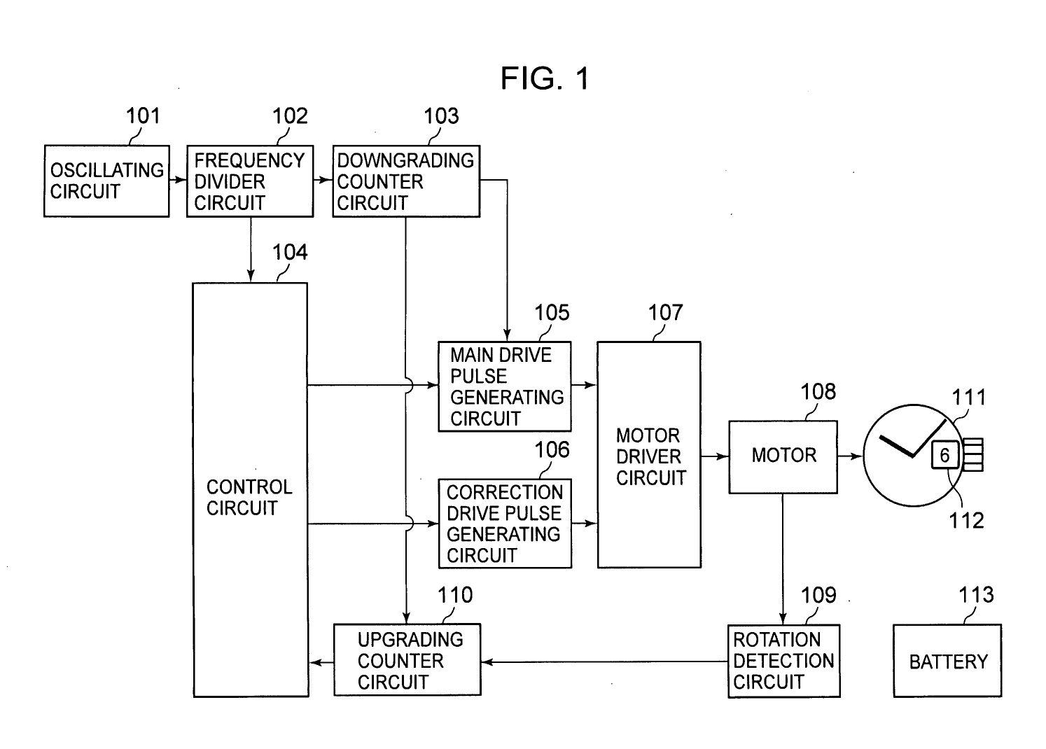

FIG. 1 is a block diagram of an analogue electronic watch using a stepping motor control circuit according to an embodiment of the invention, and shows an analogue electronic wrist watch, as an example.

In FIG. 1, the analogue electronic watch includes an oscillation circuit 101 configured to generate signals of a predetermined frequency, a frequency divider circuit 102 configured to divide the frequency of the signals generated by the oscillation circuit 101 and generate a clock signal which serves as a reference when counting the time, a control circuit 104 configured to perform control of respective electronic circuit elements which constitute the electronic watch and of drive pulse change, and a downgrading counter circuit 103 configured to output a downgrading signal for downgrading a main drive pulse P1 every time when a clock signal from the frequency divider circuit 102 is counted for a predetermined time and output a reset signal to an upgrading counter circuit 110.

The analogue electronic watch also includes a main drive pulse generating circuit 105 configured to select a main drive pulse from among plural types of the main drive pulses P1 having drive energies different from each other on the basis of a control signal from the control circuit 104 and output the selected main drive pulse, a correction drive pulse generating circuit 106 configured to output a correction drive pulse P2 having a larger drive energy than that of the respective main drive pulses P1 on the basis of the control signal from the control circuit 104, and a motor driver circuit 107 configured to rotate a stepping motor 108 in response to the main drive pulse P1 from the main drive pulse generating circuit 105 and the correction drive pulse P2 from the correction drive pulse generating circuit 106.

The analogue electronic watch also includes the stepping motor 108, an analogue display unit 111 including time-of-day hands rotated by the stepping motor 108 for displaying the time of day and a calendar display unit 112, a rotation detection circuit 109 configured to detect an induced signal VRs generated by the stepping motor 108 in a predetermined rotation detection segment and output a detection signal indicating the state of rotation, the upgrading counter circuit 110 configured to count the number of times that the rotation detection circuit 109 detects a short of drive energy of the main drive pulse P1 (it corresponds to the number of times the main drive pulse P1 is upgraded) and output the detected number of times to the control circuit 104, and then reset the counted value to zero in response to the reset signal, and a battery 113 as a power source for supplying an electric power to the circuit elements of the analogue electronic watch such as the stepping motor 108.

The rotation detection segment for detecting whether the stepping motor 108 is rotated or not is provided immediately after the rotation of the stepping motor 108 driven by the main drive pulse P1. The rotation detection circuit 109 detects the state of rotation which indicates whether the stepping motor 108 is rotated normally or not (that is, whether the drive energy of the main drive pulse P1 is sufficient or short) by determining whether the induced signal VRs generated by free oscillations occurring immediately after the driving of the stepping motor 108 exceeds a predetermined reference threshold voltage Vcomp or not.

The oscillation circuit 101 and the frequency divider circuit 102 constitute a signal generating unit, the analogue display unit 111 constitutes a notifying unit, and the rotation detection circuit 109 constitutes a rotation detecting unit. The main drive pulse generating circuit 105 and the correction drive pulse generating circuit 106 constitute a drive pulse generating unit. The motor driver circuit 107 constitutes a motor driving unit. The oscillation circuit 101, the frequency divider circuit 102, the downgrading counter circuit (first counter circuit) 103, the control circuit 104, the main drive pulse generating circuit 105, the correction drive pulse generating circuit 106, the motor driver circuit 107, and the upgrading counter circuit (second counter circuit) 110 constitute a control unit.

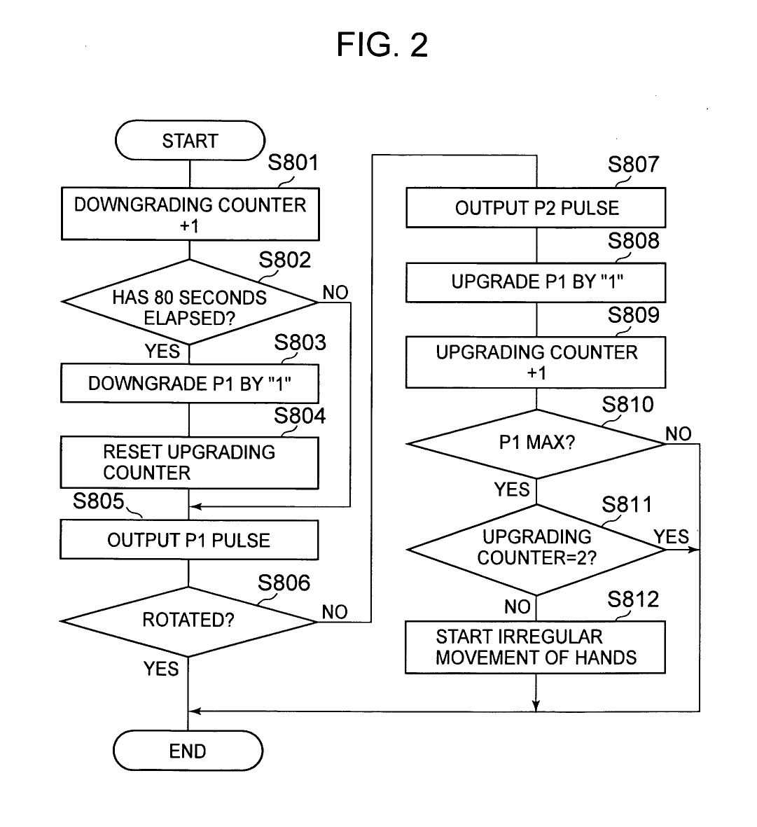

FIG. 2 is a flowchart showing the operation of the embodiment of the invention.

Referring now to FIG. 1 and FIG. 2, the action of the embodiment of the invention will be described in detail.

First of all, an outline of the operation to display the time of day or the date in the normal state will be described. In FIG. 1, the oscillation circuit 101 generates a signal of a predetermined frequency, and the frequency divider circuit 102 divides the signal generated by the oscillation circuit 101 to generate a clock signal (for example a signal at a cycle of one second) as a reference of time counting, and outputs the generated clock signal to the downgrading counter circuit 103 and the control circuit 104.

The control circuit 104 outputs a main drive pulse control signal to the main drive pulse generating circuit 105 to rotate the stepping motor 108 in response to the clock signal.

The main drive pulse generating circuit 105 outputs the main drive pulse P1 having an energy rank corresponding to the main drive pulse control signal from the control circuit 104 to the motor driver circuit 107. The motor driver circuit 107 rotates the stepping motor 108 with the main drive pulse P1. The stepping motor 108 is rotated with the main drive pulse P1 and then rotates the time-of-day hands of the analogue display unit 111 or the calendar display unit 112. Accordingly, when the stepping motor 108 is normally rotated, the current time display by the time-of-day hands or the data display by the calendar display unit 112 is updated in the analogue display unit 111.

The downgrading counter circuit 103 performs a time counting operation by counting the clock signal from the frequency divider circuit 102, outputs a downgrading signal for downgrading the main drive pulse P1 at a predetermined cycle (for example, a cycle of 80 seconds), and outputs a reset signal for resetting the counted value of the upgrading counter circuit to the upgrading counter circuit 110.

The main drive pulse generating circuit 105 downgrades the energy of the main drive pulse P1 by one rank in response to the downgrading signal, and outputs the downgraded main drive pulse P1 to the motor driver circuit 107. The motor driver circuit 107 drives the stepping motor 108 with the main drive pulse downgraded by one rank.

The rotation detection circuit 109 detects the state of rotation of the stepping motor 108 by detecting the induced signal VRs generated by the free oscillations of the stepping motor 108 in a rotation detection segment immediately after the completion of drive of the stepping motor 108 with the main drive pulse P1. When the induced signal VRs exceeds the predetermined reference threshold voltage Vcomp, the rotation detection circuit 109 detects the rotation of the stepping motor 108 (in other words, the fact that the energy of the main drive pulse P1 is sufficient), and outputs a first signal indicating that the energy of the main drive pulse P1 is sufficient. In contrast, when the induced signal VRs does not exceed the reference threshold voltage Vcomp, the rotation detection circuit 109 detects that the stepping motor 108 is not rotated (that is, the energy of the main drive pulse P1 is short), and outputs a second signal indicating that the energy of the main drive pulse P1 is short.

Upon receipt of the second signal via the upgrading counter circuit 110, the control circuit 104 acts to output the main drive pulse control signal to the main drive pulse generating circuit 105 at the time of subsequent driving and upgrade the rank of the main drive pulse P1 by a rank. Therefore, the number of times of the generation of the second signal and the number of times of upgrading of the main drive pulse P1 are equal.

The main drive pulse generating circuit 105 drives the stepping motor 108 with the main drive pulse P1 with energy upgraded by one rank in response to the control signal.

The upgrading counter circuit 110 counts the second signal and outputs the counted value to the control circuit 104, and resets the counted value to zero in response to the reset signal from the downgrading counter circuit 103.

The control circuit 104 determines that the voltage of the battery 113 as a power source lowered to a level equal to or lower than the predetermined value when the counted value of the upgrading counter circuit 110 reaches the predetermined value.

When the rotation detection circuit 109 detects that the stepping motor 108 is not rotated, that is, when the control circuit 104 receives the second signal from the rotation detection circuit 109 via the upgrading counter circuit 110, the control circuit 104 outputs a correction drive pulse control signal to the correction drive pulse generating circuit 106. The correction drive pulse generating circuit 106 forcedly rotates the stepping motor 108 with the correction drive pulse P2 via the motor driver circuit 107 in response to the correction drive pulse control signal.

Hereinafter, the operation of determination that the voltage of the battery 113 lowers to a level equal to or lower than a predetermined value will be described in detail.

The downgrading counter circuit 103 counts a clock signal supplied at a predetermined cycle (for example, a cycle of one second) from the frequency divider circuit 102 (Step S801). When the downgrading counter circuit 103 counts the clock signal for a predetermined time (for example, 80 seconds) (Step S802), the downgrading counter circuit 103 outputs a downgrading signal for downgrading the main drive pulse P1 by one rank to the main drive pulse generating circuit 105 (Step S803) and, simultaneously, outputs a reset signal to the upgrading counter circuit 110 (Step S804). The predetermined time described above is a time longer than the driving cycle of the stepping motor 108.

The main drive pulse generating circuit 105 downgrades the energy rank of the main drive pulse P1 by one rank in response to the downgrading signal from the downgrading counter circuit 103, and outputs the downgraded main drive pulse P1 to the motor driver circuit 107 (Step S805). The motor driver circuit 107 drives the stepping motor 108 with the main drive pulse P1 downgraded by one rank.

The rotation detection circuit 109 detects the state of rotation of the stepping motor 108. When the rotation detection circuit 109 detects that the stepping motor 108 is rotated, the rotation detection circuit 109 outputs the first signal. In contrast, when the rotation detection circuit 109 detects that the stepping motor 108 is not rotated, the rotation detection circuit 109 outputs the second signal. The upgrading counter circuit 110 counts the second signal and outputs the counted value to the control circuit 104. When the control circuit 104 receives the first signal from the rotation detection circuit 109 via the upgrading counter circuit 110, the control circuit 104 determines that the stepping motor 108 is rotated, and hence ends the process (Step S806).

When the downgrading counter circuit 103 does not count the predetermined time in the Step S802, the process immediately goes to the Step S805.

When the control circuit 104 receives the second signal from the rotation detection circuit 109 via the upgrading counter circuit 110 in the Step S806, the control circuit 104 determines that the stepping motor 108 is not rotated, and outputs a correction drive pulse control signal to the correction drive pulse generating circuit 106. The correction drive pulse generating circuit 106 outputs the correction drive pulse P2 to the motor driver circuit 107 in response to the correction drive pulse control signal (Step S807). The motor driver circuit 107 forcedly rotates the stepping motor 108 with the correction drive pulse P2.

Subsequently, the control circuit 104 outputs a main drive pulse control signal to the main drive pulse generating circuit 105 so as to drive the stepping motor 108 with the main drive pulse P1 upgraded by one rank at the time of the subsequent driving (Step S808). The main drive pulse generating circuit 105 drives the stepping motor 108 with the main drive pulse P1 with drive energy upgraded by one rank in response to the main drive pulse control signal at the time of the subsequent driving.

Subsequently, the upgrading counter circuit 110 increments the counted value of the second signal by one, and outputs it to the control circuit 104 (Step S809). The control circuit 104 determines whether or not the main drive pulse P1 becomes the main drive pulse of a predetermined rank (in this embodiment, a main drive pulse P1max at the highest rank) (Step S810). If it is determined that the main drive pulse P1 becomes the main drive pulse P1 of the predetermined rank described above, the control circuit 104 determines whether or not the counted value of the upgrading counter circuit 110 is equal to or higher than the predetermined value (for example, values of “2” or higher) (Step S811).

When the counted value of the upgrading counter circuit 110 is equal to or higher than the predetermined value in Step S811, the control circuit 104 determines that the voltage of the battery 113 lowers to a level equal to or lower than the predetermined voltage (for example, a marginal voltage for driving the stepping motor 108), and controls the main drive pulse generating circuit 105 so as to drive the stepping motor 108 to cause the time-of-day hands of the analogue display unit 111 to be moved in a mode different from before the voltage of the battery 113 is determined to be a level equal to or lower than the predetermined value (irregular movement) (Step S812). Accordingly, the time-of-day hand is moved irregularly in the analogue display unit 111, and hence the fact that the voltage of the battery 113 lowered to a level equal to or lower than the predetermined value is notified, so that a user is urged to replace the battery.

The control circuit 104 ends the process when the main drive pulse P1 is not the main drive pulse of the predetermined rank described above in Step S810. In contrast, when the counted value of the upgrading counter circuit 110 does not reach the predetermined value described above in Step S811, the control circuit 104 determines that the cause of the upgrading of the main drive pulse P1 is a load increase of the stepping motor 108 (for example, the load increase due to the driving of the calendar display unit 112), and ends the process.

As described above, the stepping motor control circuit and the analogue electronic watch according to the embodiment include the battery 113 configured to supply an electric power at least to the stepping motor 108, the rotation detection circuit 109 configured to detect the state of rotation of the stepping motor 108, and a control unit configured to select an upgraded main drive pulse P1 from a plurality of the main drive pulses P1 having energy ranks different from each other and drives the stepping motor 108 with the selected main drive pulse P1 when the rotation detecting unit 109 detects an energy shortage at the time of rotation with the main drive pulse P1. The control unit is configured to determine that the voltage of the battery 113 lowered to a level equal to or lower than the predetermined value if the main drive pulse P1 reaches the main drive pulse P1max by upgrading by the number of times smaller than the predetermined number of times within a predetermined time.

In this manner, whether or not the battery 113 is consumed to a marginal level for driving the stepping motor 108 is determined on the basis of the state of rotation of the stepping motor 108 to determine whether or not the battery 113 remains. Also, a plurality of ranks of main drive pulses are provided and a marginal drive pulse having a predetermined energy is set, so that when the main drive pulse is upgraded to the marginal drive pulse the voltage is determined to be marginal for driving the stepping motor. In addition, when the main drive pulse is upgraded by a plurality of ranks within a predetermined time, it is determined to be a load for advancing the calendar, and not to be the marginal voltage for driving the stepping motor. Furthermore, when a main drive pulse is upgraded more than a predetermined number of times within a predetermined time in reaching the main drive pulse P1 of the predetermined rank, it is determined that it is caused by the load increase of the stepping motor 108, while when a main drive pulse is upgraded less than a predetermined number of times within the predetermined time in reaching the main drive pulse P1 of the predetermined rank, it is determined that the voltage of the power source lowered to a level equal to or lower than the predetermined value.

Therefore, detection of lowering of a source voltage is enabled without providing a circuit specific for voltage detection such as a comparator circuit.

In this embodiment, the predetermined main drive pulse is set to be the main drive pulse P1max of the highest rank used when driving the time-of-day hands or the calendar display unit 112 in the normal state. However, other main drive pulses P1 may be employed as long as it is a main drive pulse used for driving the stepping motor 108 in the normal state.

In this embodiment, the rotation detection segment is configured to be a single segment, and the state of rotation of the stepping motor 108 is detected on the basis of whether or not the induced signal VRs exceeds the reference threshold voltage Vcomp in the corresponding segment. However, it is also possible to divide the rotation detection segment into a plurality of segments so as to determine the state of rotation according to the pattern of combination of the segments in which the induced signal VRs exceeding the reference threshold voltage Vcomp is generated.

In this embodiment, the energy rank is changed by changing the pulse width using the main drive pulse of a rectangular wave as the main drive pulse P1. However, it is also possible to change the drive energy by employing a comb-teeth type main drive pulse and changing a duty ratio while maintaining the pulse width. Alternatively, it is also possible to change the drive energy by changing the number of comb teeth while maintaining the duty ratio (in this case, the pulse width is changed), or to change the drive energy by changing the pulse voltage.

The invention is also applicable to stepping motors for driving things other than the time-of-day hands or the calendar.

Although the invention has been described using the electronic watch as an example of application of the stepping motor, it is applicable to electronic apparatuses using a motor.

The stepping motor control circuit according to the invention is applicable to various electronic apparatuses using a stepping motor.

The electronic watch according to the invention may be applied to various analogue electronic clocks having a calendar function, such as an analogue electronic wrist watch having a calendar function or analogue electronic standing clocks having a calendar function, and also to other various analogue electronic watches.

What is claimed is:

1. A stepping motor control circuit comprising:
a power source configured to supply an electric power at least to a stepping motor;
a rotation detecting unit configured to detect the state of rotation of the stepping motor; and
a control unit configured to select an upgraded main drive pulse from a plurality of main drive pulses having energy ranks different from each other and drive the stepping motor when the rotation detecting unit detects an energy shortage at the time of rotation with the main drive pulse, wherein
the control unit determines that the voltage of the power source lowered to a level equal to or lower than a predetermined value when a main drive pulse is upgraded a number of times smaller than the predetermined number of times within a predetermined time in reaching the main drive pulses of a predetermined rank.

2. A stepping motor control circuit according to claim 1, wherein the control unit determines that a load of the stepping motor is increased instead of determining that the voltage of the power source lowers to a level equal to or lower than the predetermine value when a main drive pulse is upgraded a number of times equal to or larger than the predetermined number of times within the predetermined time in reaching the main drive pulse of the predetermined rank.

3. A stepping motor control circuit according to claim 1, wherein the control unit includes a first counter circuit configured to output a reset signal at a cycle of the predetermined time and a second counter circuit configured to count the number of times that the main drive pulse is upgraded and to be reset in a counted value by the reset signal, and determines that the voltage of the power source lowers to a level equal to or lower than the predetermined value if the counted value of the second counter circuit does not reach the predetermined value when a main drive pulse is upgraded to the main drive pulse of the predetermined rank.

4. A stepping motor control circuit according to claim 2, wherein the control unit includes a first counter circuit configured to output a reset signal at a cycle of the predetermined time and a second counter circuit configured to count the number of times that the main drive pulse is upgraded and to be reset in a counted value by the reset signal, and determines that the voltage of the power source lowers to a level equal to or lower than the predetermined value if the counted value of the second counter circuit does not reach the predetermined value when a main drive pulse is upgraded to the main drive pulse of the predetermined rank.

5. A stepping motor control circuit according to claim 3, wherein the control unit determines that a load of the stepping motor is increased instead of determining that the voltage of the power source lowers to a level equal to or lower than the predetermine value if the counted value of the second counter circuit is the predetermined value or larger when the main drive pulse is upgraded to the main drive pulse of the predetermined rank.

6. A stepping motor control circuit according to claim 4, wherein the control unit determines that a load of the stepping motor is increased instead of determining that the voltage of the power source lowers to a level equal to or lower than the predetermine value if the counted value of the second counter circuit is the predetermined value or larger when the main drive pulse is upgraded to the main drive pulse of the predetermined rank.

7. A stepping motor control circuit according to claim 1, wherein the predetermined voltage is a marginal voltage for driving the stepping motor.

8. A stepping motor control circuit according to claim 2, wherein the predetermined voltage is a marginal voltage for driving the stepping motor.

9. A stepping motor control circuit according to claim 3, wherein the predetermined voltage is a marginal voltage for driving the stepping motor.

10. A stepping motor control circuit according to claim 4, wherein the predetermined voltage is a marginal voltage for driving the stepping motor.

11. A stepping motor control circuit according to claim 5, wherein the predetermined voltage is a marginal voltage for driving the stepping motor.

12. A stepping motor control circuit according to claim 6, wherein the predetermined voltage is a marginal voltage for driving the stepping motor.

13. A stepping motor control circuit according to claim 1, wherein the main drive pulse of the predetermined rank is a main drive pulse of the highest rank.

14. A stepping motor control circuit according to claim 2, wherein the main drive pulse of the predetermined rank is a main drive pulse of the highest rank.

15. A stepping motor control circuit according to claim 3, wherein the main drive pulse of the predetermined rank is a main drive pulse of the highest rank.

16. A stepping motor control circuit according to claim 4, wherein the main drive pulse of the predetermined rank is a main drive pulse of the highest rank.

17. A stepping motor control circuit according to claim 5, wherein the main drive pulse of the predetermined rank is a main drive pulse of the highest rank.

18. A stepping motor control circuit according to claim 1, wherein when the control unit determines that the voltage of the power source lowered to a level equal to or lower than the predetermined value the control unit drives the stepping motor in a mode different from that before it determines that the voltage of the power source lowered to a level equal to or lower than the predetermined value.

19. An analogue electronic watch having a stepping motor configured to rotate time-of-day hands, and a stepping motor control circuit configured to control the stepping motor,
wherein the stepping motor control circuit according to claim 1 is used as the stepping motor control circuit.

20. An analogue electronic watch according to claim 19, comprising a notifying unit configured to notify that the voltage of the power source lowered to a level equal to or lower than a predetermined value when the control unit of the stepping motor control circuit determines that the voltage of the power source lowered to a level equal to or lower than the predetermined value.
